(19) United States
(12) Patent Application Publication
(10) Pub. No.: US 2007/0003348 A1
(43) Pub. Date: Jan. 4, 2007

(54) Ultra high capacity line-matrix printer ribbon

(76) Inventors: Jeng-Dung Jou, Irvine, CA (US); Y. Grant Chang, Irvine, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/451,987

(22) Filed: Jun. 13, 2006

Related U.S. Application Data
(60) Provisional application No. 60/692,195, filed on Jun. 17, 2005.

(51) Int. Cl. B41J 31/09

(52) U.S. Cl. 400/237

(57) ABSTRACT

A print ribbon for an impact printer uses a heavy-duty 70/70 denier fabric having approximately 230 threads per square inch. The fabric can be textured. The print ribbon uses an ink having a viscosity of approximately 2000 cps to 3400 cps, a liquid pigment, and a color strength of approximately 1.5 to 2.0, with the pigment content being 15% or less (e.g., 2.5%) and the ribbon having an ink concentration of approximately 19%.

### CROSS REFERENCE TO RELATED APPLICATIONS

The present invention claims priority to U.S. Provisional Application Ser. No. 60/692,195, filed Jun. 17, 2005, and which is incorporated by reference in its entirety.

### BACKGROUND

1. Field of Invention

The present invention relates printer ribbons and print ribbon inks.

2. Related Art

Line matrix and other types of impact printing systems utilize print ribbons to transfer images, such as letters and characters, onto media or paper. The print ribbons hold ink so that hammers striking the print ribbon transfer corresponding ink images to the paper. However, print ribbons have a finite life, as continued impact of the hammers may wear down the ribbon fabrics so that it no longer can effectively retain ink or even wear a hole through the ribbon. Also, the ink may have a tendency to oxidize and dry out once it is in the print ribbon. This could cause the decrease of ribbon shelf life, and the result is the inefficient use of the inked ribbon. The costs are therefore increased due to the need for replacing or re-inking the ink ribbons more frequently.

Current printer ribbons are formed from different materials and fabrics of different thicknesses. The type of ribbon depends on various factors, such as price and intended use. Also, different ribbons have different types of inks and ink contents for optimal performance. For example, if too much ink is placed on a thin ribbon, the ink may smear on the paper. However, the same amount of ink may be ideal with a thicker, more absorbent ribbon fabric material. Thus, there are many factors in determining an optimal ribbon and the type and amount of ink to use for the ribbon.

Therefore, there is a need for a line matrix printer ribbon that overcomes the performance disadvantages discussed above.

### SUMMARY

According to one aspect of the invention, a print ribbon uses a 5-mil 230 threads per square inch fabric constructed with 70 denier warp (yarn) and 70 denier filling (yarn). The thickness can range from 5.0 to 5.7 mil and the threads per square inch can range from 210 to 250 in one embodiment. Such a thick ribbon can withstand the high forces delivered by the impact printing mechanism, resulting in a longer-lasting ribbon. In one embodiment, the fabric is textured, thereby enabling the ribbon to hold more ink and provide extended character yield, i.e., longer ribbon life.

According to another embodiment, printer ink of approximately 18% to 20% (e.g., 19%) concentration [(weight of inked ribbon minus weight of un-inked ribbon)/(weight of inked ribbon)], such as in the printer ribbon of the present invention. At this concentration, initial density performance and initial barcode print quality are both optimized. Furthermore, using this concentration with the ribbon of the present invention, the ink load is higher than with conventional generic fiber ribbons.

In one embodiment, the pigment content, such as carbon black, is between 0% and 15%, and the ink is mixed with a liquid pigment for easier manufacturing. In another embodiment, the pigment content is around 2.5%, e.g., weight percentage of carbon black in the ink.

The printer ribbon and/or ink of the present invention provides numerous performance advantages, such as increased life, higher ink retention, good print quality, less ink migration to print mechanisms, less print dot smearing, long shelf life, better printout light fastness, and improved fabric ink ability.

Embodiments of the present invention and their advantages are best understood by referring to the detailed description that follows.

### BRIEF DESCRIPTION OF THE DRAWING

FIG. 1 is a graph showing the Macbeth density as a function of the number of characters printed for different ink loads;

FIG. 2 is a graph showing barcode print quality as a function of the number of labels printed for different ink loads;

FIG. 3 is a chart showing viscosity as a function of dye concentration;

FIG. 4 is a graph showing the Macbeth density as a function of the number of characters printed for different color strengths;

FIG. 5 is a graph showing viscosity as a function of rotation speed for different types of ink.

FIG. 6A is a photo showing a texturized yarn for making a print ribbon according to one embodiment; and

FIG. 6B is a photo showing a flat yarn.

It should be appreciated that like reference numerals are used to identify like elements illustrated in one or more of the figures.

### DETAILED DESCRIPTION

According to one embodiment of the present invention, a print ribbon is approximately 5-mil thick (e.g., 5.0 mil to 5.7 mil) and made of a fabric of 70 denier warp (yarn) and 70 denier filling (yarn) (70/70 denier), where denier is a unit of weight for describing the size of filament yarn. For example, the lower the number, the lighter (or finer) the yarn, and the higher the number, the heavier (or thicker) the yarn. In particular, denier is one unit of measure for the linear mass density of fibers. Denier is defined as the mass in grams per 9000 meters. An example of a denier is 1 denier equals 1 gram per 9000 meters equals 0.05 grams per 450 meters.

The print ribbon contains approximately 210 to 250 (e.g., 230) threads per square inch in one embodiment. The print ribbon construction enables it to withstand the high force delivered by the impact printing mechanism.

In another embodiment, the 70/70 denier fabric is textured, where textured styles use a flat warp and a textured filling. Texturizing is the process of crimping the individual filaments to provide increased interstices in which ink can reside. FIG. 6A is a photo showing a textured yarn used for a print ribbon according to one embodiment. For comparison, FIG. 6B is a photo showing a flat yarn. As seen, the textured yarn has more grooves and is not as smooth as the flat yarn. These types of fabrics can hold up with more ink and provide extended character yield, i.e., longer ribbon life. In addition, high weaving density, i.e., the total number of threads per square inch of fabric and is the sum of the warp count and the filling count, combined with the 70/70 denier fabric construction increases ink capacity and print life, as compared with the commonly used 40/70 denier fabric.

According to another aspect of the invention, the print ribbon uses specific inks and concentrations. In one embodiment, the ink has a high concentration of oil-based color dye chemicals, such as mainly blue, purple, orange, and/or other dyes to blend with the nigrosine to increase the ink color strength. The result is longer printing yield and darker image tone.

Ink oxidation, which reduces shelf life, is caused by the reaction between unsaturated fatty acid moieties (e.g., Oleic acid) and oxygen. The rate of oxidation of these fatty acids increases with the degree of un-saturation, i.e., more available reactive sites. The combination of high dye concentration and adequate ink manufacturing process greatly reduces the total amount of the un-saturated fatty acids, resulting in less oxidation and longer shelf life.

The ink shows a Newtonian behavior throughout the operational inking range (e.g., 5 to 15 rpm). Newtonian fluid represents that the viscosity of the fluid remains constant as the shear rate is varied, i.e., the ink has better ink ability. Optimal ribbon ink concentration helps to eliminate ink smearing and free flowing without sacrificing ribbon life performance.

Pigment in oil-based inks serves several functional purposes. Pigment is typically added to the ink in solid form, carbon black powder, or liquid form, which the carbon black has been pre-mixed in an oil suspension, so-called dispersion. Dispersing the carbon black particulates in ink requires high shear energy. This typically is done by a ball milling process. Therefore, carbon black liquid dispersions are used to achieve the good results without applying high shear energy during the ink-making process.

An ideal dispersion of carbon black would be the condition in which all agglomerates are broken down into primary aggregates, where each primary aggregate is separated from every other aggregate and completely covered by vehicle. Primary aggregates are the characteristic units of carbon black and are not broken down further under normal dispersion conditions. In this stage, each separated primary aggregate must adsorb sufficient vehicle to cover its surface completely thus stabilizing the dispersion. A well-prepared carbon black dispersion and lower pigment content will help to prevent re-agglomeration or settling. However, the minimum loading levels of pigments are needed in order to achieve reasonable opacity and IR readability at very thin printed thickness.

In general, inks are primarily composed of vehicle, colorants, and supplementary additives. The function of the vehicle, which can be a fatty acid such as an oleic acid, is to act as a carrier and as a binder to affix the colorants and pigments to the printed surface. The nature of the vehicle may determine in large measure the tack and flow characterization including viscosity. Colorants include pigment and dyes, such as carbon black. Pigments are finely divided solid materials that give ink color and opacity or transparency. Dyes are soluble in the material they are used in and are commonly used in line matrix printer inks. Supplementary additives make up only few percent of total inks, but may have tremendous effects of the performance of the ink such as anti-oxidant, waxes, surfactants, and resins. Supplementary additives in the way of dyes can be such as induline, azine, methyl violet, or nigrosine, or other dyes which can adjust viscosity and flow properties.

Basically, the manufacture of inks is known and is essentially just a mixing process. Beforehand, a vehicle with dyes (e.g., dye oleate), pigment dispersion, and additives have to be prepared separately. The vehicle or carrier can include, for example, organic acids such as aliphatic carboxylic acids such as lauric acid, myristic acid, palmitic acid, stearic acid, isostearic acid, oleic acid, adipic acid, citric acid and ascorbic acid; aromatic carboxylic acids such as benzoic acid, salicylic acid, phthalic acid, isophthalic acid, terephthalic acid, naphthoic acid, gallic acid and tannic acid; and sulfonic acids such as dodecyl sulfonic acid and alkylbenzenesulfonic acid.

Dispersion of pigments into vehicles may use mixing and milling techniques. In some cases, pigments can be purchased or manufactured in a liquid suspension form which makes the ink manufacturing process much easier. Various oily substances can also be used as the dissolution medium for the dye or the dispersion medium for pigment. Examples of the oily substances include among others: vegetable oils such as rapeseed oil, castor oil and soybean oil; animal oils such as beef foot oil; higher fatty acids such as isostearic acid and oleic acid and mixtures thereof.

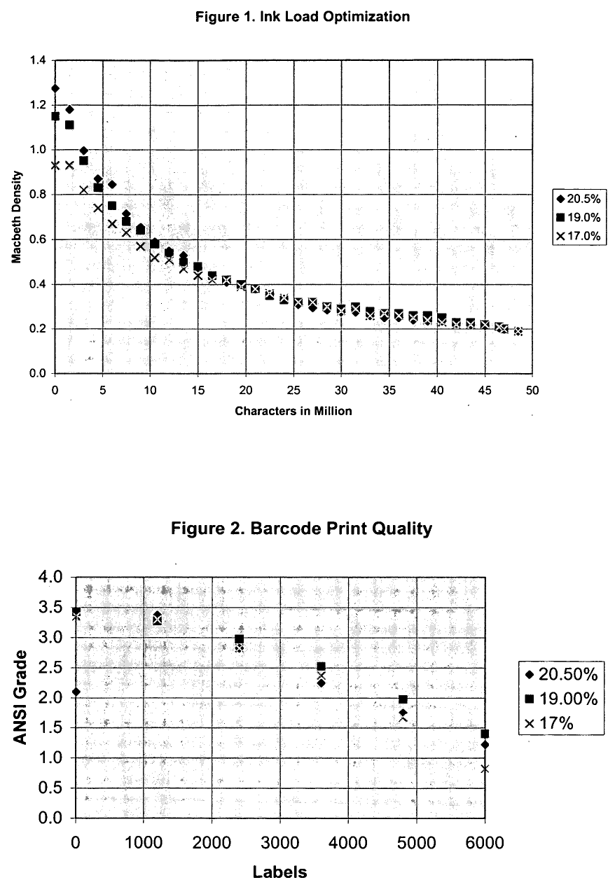

In one embodiment, the 70/70 denier print ribbon, with textured fabric and 230-thread count, uses an ink concentration of approximately 19%, resulting in an ink load of approximately 0.46 grams per yardage. The ink concentration can range from 18% to 20%, and the ink load can range from 0.44 to 0.49 grams per yardage in different embodiments. Different ink concentrations were used to measure Macbeth density as a function of the number of characters printed and barcode print quality (ANSI Grade) as a function of number of labels printed. FIGS. 1 and 2, respectively, show the results. As seen in FIG. 1, an ink concentration of 17.0% has poor density performance, as compared with ink concentrations of 19.0% and 20.5%. Ink concentration is measured or defined herein as the weight of the inked ribbon minus the weight of the un-inked ribbon divided by the weight of the inked ribbon. Density performance is similar for the 19.0% and 20.5% concentrations.

As seen in FIG. 2, however, the worst barcode print quality is for the ribbon inked at 20.5% concentration. Barcode print quality for ink concentrations of 17.0% and 19.0% are similar. Thus, based on density performance and barcode print quality, the optimal ink concentration is approximately 19%±1%. This optimal ink concentration is for the 70/70 denier textured ribbon. Table 1 below shows optimal ink concentrations for other ribbon types.

TABLE 1

| | Generic | Generic | High Capacity |
|---|---|---|---|
| | 4-mil | 5-mil | 5-mil |
| | ribbon fabric | ribbon fabric | ribbon fabric |
| Caliper (Mil) | 4 (flat) | 5 (flat) | 5.4 (textured) |
| Warp Denier/No. Filaments | 40/34 | 40/34 | 70/34 |
| Fill Denier/No. Filaments | 40/34 | 70/34 | 70/34 |
| Weight (Oz/Sq. Yd.) | 1.57 | 2.01 | 2.38 |
| Optimum Ink | 21% | 19% | 19% |
| concentration (±1%) | | | |
| Ink (g)/yard | 0.35 | 0.39 | 0.46 |

As sees from Table 1, at optimal ink concentrations, the 70/70 denier textured ribbon has the highest ink load at 0.46 (grams per yardage), as compared with 0.39 for a generic 5-mil ribbon and 0.35 for a generic 4-mil ribbon.

Ink viscosity, in one embodiment, is between 2000 centipoises (cps) and 3400 cps. Viscosity for an ink is a measure of the ink's thickness. Low viscosity printer ink loses shear strength at high temperatures even when disposed on a carrier such as a printer ink ribbon. Within impact printing applications such as those using an ink ribbon, this can result in ink smearing and ink migration, which lowers the print quality. On the other hand, the viscosity of an ink that performs well at elevated temperatures becomes excessively high as to its viscosity at lower temperatures. Excessively high ink viscosity exhibits other printing problems. The problems can include increased difficulty of the inking process, poor transfer into and out of the printer ribbon, resistance to pumping through small tubing, and a very slow transfer through foam materials. Table 2 below shows how low and high ink viscosity affects, in general, various ink or print parameters.

TABLE 2

| | Ribbon | | Ink | Ink | Ink | Operating Temp. |
|---|---|---|---|---|---|---|
| Ink Viscosity | Yield | Oxidation | ability | Smearing | Migration | (10-40° C.) |
| Low | − | − | + | − | − | + |
| High | + | + | − | + | + | − |

Viscosity can be adjusted in various ways as each ingredient contributes to the final viscosity. In addition to the vehicle or carrier, other ingredients can be added which can further adjust the viscosity. Examples of viscosity-adjusting agents include among others mineral oils, such as motor oil, and synthetic oils, such as olefin-polymerized oil (e.g. ethylene hydrocarbon oil, butylene hydrocarbon oil, and the like), diester oils (e.g. dioctyl phthalate, dioctyl sebacate, di(1-ethylpropyl) sebacate, dioctyl azelate, dioctyl adipate, and the like), and silicone oils (e.g. linear dimethyl polysiloxane having a low viscosity, and the like). Mixtures of two or more kinds can also be used.

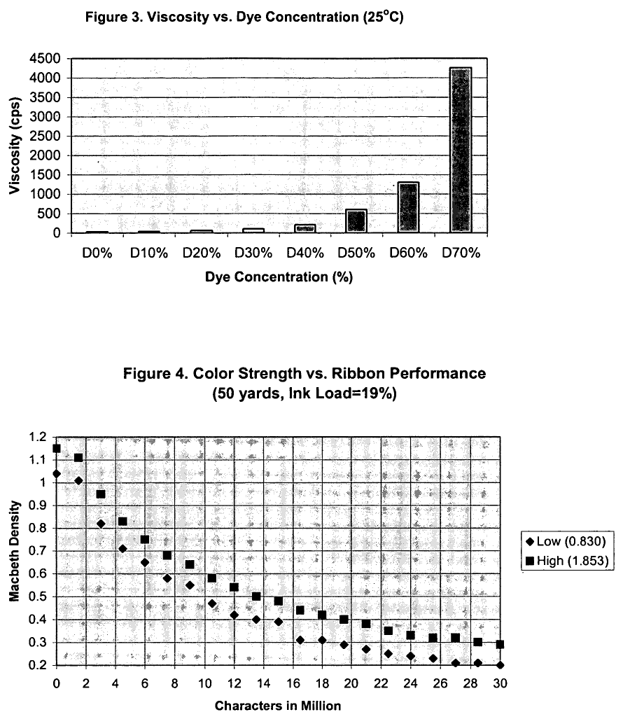

In one embodiment, color strength or absorbance is between approximately 1.5 to 2.0. FIG. 3 shows the final viscosity versus dye concentration at 25° C. The vehicle is oleic acid and black dye is nigrosine. The reaction of oleic acid with nigrosine will form dye oleate. With the above viscosity range (2000 cps to 3400 cps), the range of optimal color strength is within 1.5 to 2.0. Table 3 below shows the color strength or absorbance for different types of ribbon at a wavelength of 580 nm peak.

TABLE 3

| | Color Strength = Absorbance |
|---|---|
| Generic Ribbon Ink (1) | 1.089 |
| Generic Ribbon Ink (2) | 1.342 |
| High Color Strength | 1.853 |
| Low Color Strength | 0.830 |

The solution is prepared with 0.1 grams of ink diluted by 50-ml mixture of methanol and chloroform and then a 2-mil mixture is further diluted by 50-mil methanol. Samples are scanned by spectro-photometers. As seen, the ink color strength is higher (1.853) for the 70/70 denier ribbon than for other conventional ribbons. FIG. 4 shows ribbon performance as a function of number of characters printed for the high and low ink color strengths of Table 3. As seen, the high color strength shows a better performance.

In one embodiment, the pigment content of the ink is approximately 0% to 15%. Such a low pigment ink has advantages over high pigment inks. Newtonian fluid flow represents that the fluid's viscosity remains constant as the shear rate is varied. In general, the operation rotation speed of the ribbon inking machine is around 5 to 15 rpm. Non-Newtonian fluid will cause inking difficulty for variations of rotation speed during the inking process. High viscosity, high dye concentration, and low pigment ink has better ink ability (Newtonian fluid), less pigment content (no pigment settling problem), and still meets IR requirements (minimum 35 labels per yardage).

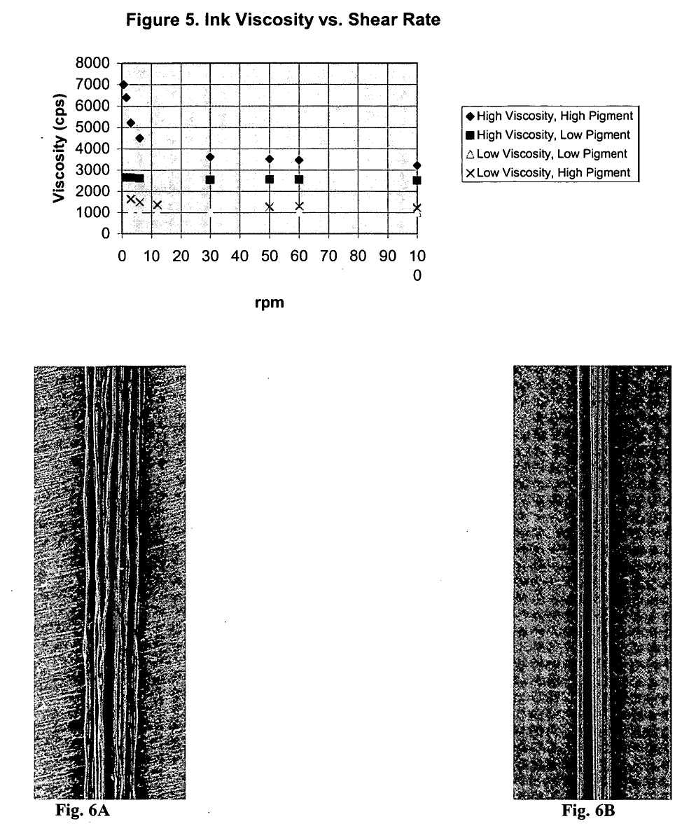

FIG. 5 shows a graph of viscosity versus rotation speed for different combinations of viscosity and pigment. A low pigment content ink, such as 2.5%, is desirable in one embodiment. High pigment content has a greater tendency to place the ink on the paper which offsets or lowers the print yield. It should also be understood that the pigments generally do not chemically bond to the carrier but rather form a relationship on the basis of Van Der Waal's forces. In effect the higher the ratio of pigment in the ink, the lesser the ribbon life or ribbon print yield because of lacking sufficient amount of dyes in the ink. Pigment content can be defined as the pigment content by weight, e.g., weight percentage of carbon black in the ink. In one embodiment, the pigment is mixed by a liquid pigment dispersion. Examples of pigment-dispersing agents include among others sorbitan fatty acid esters, polyoxyethylene sorbitan fatty acid esters, polyoxyethylene sorbitan alkyl ethers, glycerin fatty acid esters, propylene glycol fatty acid esters, polyethylene glycol fatty acid esters, polyoxyethylene alkyl ethers, hardened castor oil derivatives and polyoxyethylene castor oils. One or a mixture can be used.

Thus, the inks can be made in a conventional manner by thoroughly mixing together the ingredients in any convenient manner known to those skilled in the art. The resulting mixture can be adjusted for the desired viscosity as described herein and applied to the ribbon to the desired fabric thickness in any convenient manner.

Having thus described embodiments of the present invention, persons skilled in the art will recognize that changes may be made in form and detail without departing from the scope of the invention.

What is claimed is:

1. A print ribbon for impact printers, comprising:
a fabric comprising 70 denier warp and 70 denier filling, wherein the fabric has approximately 210 to 250 threads per square inch.

2. The print ribbon of claim 1, wherein the fabric comprises a flat warp and a textured filling.

3. The print ribbon of claim 1, wherein the fabric has 230 threads per square inch.

4. The print ribbon of claim 1, wherein the fabric holds an ink having a concentration of approximately 18% to 20%, wherein the concentration is the weight of the ribbon with the ink minus the weight of the ribbon without the ink divided by the weight of the ribbon with the ink.

5. The print ribbon of claim 4, wherein the ink has a viscosity of approximately 2000 cps to 3400 cps.

6. The print ribbon of claim 4, wherein the ink has an ink load of approximately 0.44 to 0.49 grams per yard.

7. The print ribbon of claim 4, wherein the ink has a color strength of approximately 1.5 to 2.0.

8. The print ribbon of claim 4, wherein the ink has a pigment content range from 0% to approximately 15%.

9. The print ribbon of claim 8, wherein the pigment content is approximately 2.5%.

10. The print ribbon of claim 8, wherein the ink pigment is a liquid suspension form.

11. The print ribbon of claim 1, wherein the fabric is approximately 5.0 mil to 5.7 mil thick.

12. The print ribbon of claim 1, wherein the fabric has a weight of approximately 2.00 to 2.50 ounces per square yard.

13. The print ribbon of claim 2, wherein the fabric is approximately 5.4 mil thick.

14. An inking system for impact printers, comprising:
a print ribbon comprising a fabric of 70 denier warp and 70 denier filling, wherein the fabric has approximately 210 to 250 threads per square inch; and
an ink having a viscosity of approximately 2000 cps to 3400 cps, a liquid pigment, and a color strength of approximately 1.5 to 2.0, wherein the pigment content is 15% or less and wherein the ribbon has an ink concentration of approximately 18% to 20%.

15. The inking system of claim 14, wherein the pigment content is approximately 2.5%.

16. The inking system of claim 14, wherein an ink load is approximately 0.44 to 0.49 grams per yard.

17. The inking system of claim 14, wherein the print ribbon comprises a flat warp and a textured filling.

18. The inking system of claim 14, wherein the print ribbon is approximately 5.0 mil to 5.7 thick.

19. The inking system of claim 17, wherein the print ribbon is approximately 5.4 mil thick.

20. The inking system of claim 14, wherein the print ribbon without the print ink has a weight of approximately 2.00 to 2.50 ounces per square yard.

21. The inking system of claim 14, wherein the print ribbon with the print ink has an ink load of approximately 0.46 grams per yard.
